(19) United States
(12) Patent Application Publication
(10) Pub. No.: US 2007/0272146 A1
(43) Pub. Date: Nov. 29, 2007

(54) Apparatus and method for measuring widthwise ejection uniformity of slit nozzle

(75) Inventor: Kang Il Cho, Yongin-si (KR)

Correspondence Address: STEPTOE & JOHNSON LLP, 1330 CONNECTICUT AVENUE, N.W., WASHINGTON, DC, 20036, US

(73) Assignee: K.C. TECH CO., LTD., Ansong-Shi (KR)

(21) Appl. No.: 11/798,866

(22) Filed: May 17, 2007

(30) Foreign Application Priority Data
May 23, 2006 (KR) 10-2006-0046139

(51) Int. Cl. B05C 11/00; B05C 5/00

(52) U.S. Cl. 118/73; 216/84; 118/300

(57) ABSTRACT

An apparatus for measuring ejection uniformity of a slit nozzle comprises a liquid distributor that distributes liquid for each predetermined interval with respect to a widthwise direction of the slit nozzle, the liquid being ejected from the slit nozzle; and a liquid measuring unit that measures an amount of liquid distributed by the liquid distributor.

### CROSS REFERENCE

This application claims priority under 35 USC 119 to Korean Patent Application No. 10-2006-0046139, filed on May 23, 2006, which is incorporated by reference in its entirety.

### BACKGROUND OF THE INVENTION

1. Field of the Invention

The present invention relates to an apparatus and method for measuring widthwise ejection uniformity of photoresist to be ejected from a slit nozzle of a substrate coating apparatus, and more specifically, to an apparatus and method for measuring widthwise ejection uniformity of photoresist to be ejected along a widthwise direction of a slit nozzle when the photoresist is ejected from the slit nozzle of a substrate coating apparatus.

2. Description of the Related Art

In general, when a liquid crystal display element is manufactured, a process error usually occurs in a photo process using photoresist. When the photoresist is not uniformly coated, a difference in resolution and linewidth occurs in the subsequent process. Further, a difference in refractive index occurs, thereby generating such a defect that the difference is displayed as it is.

Recently, there is a demand for reducing a process time required for coating photoresist on a substrate. Therefore, researches for a method, in which the photoresist is uniformly coated within a short time and is dried, need to be carried out.

As for a method of coating photoresist on a substrate, there are provided a roll coating method, a spin coating method, and a slit coating method. In the roll coating method, photoresist is loaded on a round roll, and the roll is rolled on a substrate in a predetermined direction such that the photoresist is coated. In the spin coating method, a substrate is placed on a disk-shaped support, and photoresist is dropped in the center of the substrate. Then, the substrate is rotated so that the photoresist is coated on the substrate by the centrifugal force. In the slit coating method, while photoresist is ejected onto a substrate through a slit-shaped nozzle, scanning is performed in a predetermined direction such that the photoresist is coated.

In the roll coating method among the above-described methods, it is difficult to precisely adjust the uniformity of photoresist film and the film thickness thereof. Therefore, in order to form a pattern with high precision, the spin coating method is used. However, the spin coating method is suitable for coating photosensitive materials on a small-sized substrate such as a wafer, but is not suitable for a substrate for flat panel display, such as a glass substrate for liquid crystal display panel, which is large-sized and heavy. That is because, as a substrate is large-sized and heavy, there are difficulties in rotating the substrate at high speed. Further, when the substrate is rotated at high speed, the substrate can be broken, or a large amount of energy is consumed. In this reason, the slit coating method is usually used for coating photoresist on a large-sized glass substrate.

FIG. 1 is a perspective view of a general slit coater. FIG. 2 is a sectional view showing a state where photoresist is coated on a substrate by the slit coater shown in FIG. 1.

Referring to FIG. 1, the slit coater 100 includes a slit nozzle 110 which coats photoresist PR on a substrate GS, a pair of nozzle transfer units 120 which transfer the slit nozzle in a predetermined direction, a photoresist supply section 115 which is attached on one of the nozzle transfer units, a first photoresist supply line 116 which delivers photoresist PR from the photoresist supply section 115 to the slit nozzle 110, and a second photoresist supply line 117 which supplies photoresist PR to the photoresist supply section 115.

The slit nozzle 110 is formed in a long bar shape. The slit nozzle 110 has an ejection port 112 formed in the center of the lower end thereof facing the substrate GS, the ejection port 112 being formed in a minute slit shape. Through the ejection port 112, a predetermined amount of photoresist PR is ejected onto the substrate GS. The photoresist supply section 115 serves to supply photoresist PR to the slit nozzle 110 and to apply a constant pressure to the photoresist PR such that the photoresist PR is ejected. Typically, the photoresist supply section 115 including a pump applies a constant pressure to the slit nozzle 110 such that the photoresist PR stored in the slit nozzle 110 is ejected onto the substrate GS by the pressure.

Referring to FIG. 2, the slit nozzle 110 of the slit coater constructed in such a manner ejects photoresist PR onto the substrate GS, while vertically advancing at predetermined speed from one end of the substrate GS. Then, the photoresist PR is uniformly coated on the substrate GS.

At this time, the slit nozzle 110 of the slit coater 100 should uniformly eject photoresist PR in a widthwise direction of the slit nozzle 110 as well as in the transfer direction of the slit nozzle 110. In order to uniformly eject photoresist PR in the transfer direction of the slit nozzle 110, a change in pressure to be applied to the photoresist PR by the photoresist supply section 115 in accordance with a time, transfer speed of the slit nozzle 110, and a distance between the substrate GS and the slit nozzle, and the like should be controlled.

On the other hand, in order to uniformly eject photoresist PR in the widthwise direction of the slit nozzle 110, the space of the ejection port according to the widthwise direction of the slit nozzle 110 should be adjusted. For this, the slit nozzle has a plurality of bolts (not shown) for adjusting the space of the ejection port, the plurality of bolts being provided to be spaced at a predetermined distance along the widthwise direction of the slit nozzle. In order to uniformly eject photoresist PR in the widthwise direction of the slit nozzle 110, the thickness distribution of photoresist PR to be ejected by the slit nozzle 110, that is, the uniformity of photoresist PR is measured with respect to the widthwise direction of the slit nozzle 100. Then, the space of the ejection port of the slit nozzle 110 is adjusted using the measured uniformity of the photoresist PR.

As such, in order to uniformly eject photoresist PR in the widthwise direction of the slit nozzle 110, the measuring of the widthwise uniformity of the slit nozzle 110 is performed a plurality of times, so that reliability of uniformity data is secured. Then, the space of the ejection port of the slit nozzle is adjusted. After that, measurement for confirming the uniformity of photoresist PR through the adjusted ejection port should be again performed a plurality of times.

Conventionally, after photoresist PR is directly coated on the substrate by a slit coater, the thickness of the coated photoresist PR is directly measured. In such a method, however, since the photoresist PR is directly coated on the substrate, the expensive substrate and photoresist PR are wasted. Further, as a substrate increases in size, an amount of consumed photoresist further increases.

Further, when the thickness of the photoresist PR coated on a substrate is measured, it is not easy to measure the thickness of the photoresist PR in a state where the photoresist PR is not dried. Therefore, after the coated photoresist PR is subjected to a drying process, the thickness thereof should be measured, which means that it is very inconvenient to measure the thickness of the coated photoresist PR. Furthermore, since the thickness of the photoresist is measured after the coated photoresist is subjected to a drying process, the thickness of the photoresist PR which is actually coated cannot be directly measured. Therefore, it is impossible to directly measure ejection uniformity of photoresist. In addition, since the thickness of the photoresist PR coated on the substrate is very small, an expensive thickness measuring equipment is needed, in order to measure the thickness.

### SUMMARY OF THE INVENTION

An advantage of the present invention is that it provides an apparatus and method for measuring ejection uniformity of a slit nozzle, which can simply and precisely measure widthwise ejection uniformity of photoresist to be ejected onto a substrate by the slit nozzle.

Additional aspect and advantages of the present general inventive concept will be set forth in part in the description which follows and, in part, will be obvious from the description, or may be learned by practice of the general inventive concept.

According to an aspect of the invention, an apparatus for measuring ejection uniformity of a slit nozzle comprises a liquid distributor that distributes liquid for each predetermined interval with respect to a widthwise direction of the slit nozzle, the liquid being ejected from the slit nozzle; and a liquid measuring unit that measures an amount of liquid distributed by the liquid distributor.

Preferably, the liquid distributor with a predetermined thickness is formed in a strip shape so as to extend in a widthwise direction of the slit nozzle, the liquid distributor having a plurality of serrated protrusions formed in the lower portion thereof such that liquid ejected into a connection portion between the protrusions is distributed left and right so as to flow toward the respective protrusions. The plurality of protrusions are formed in an inverted triangle and are continuously connected in parallel to each other.

Preferably, the liquid is water, and the liquid distributor is surface-treated so as to have hydrophobicity with respect to the liquid. The liquid distributor is surface-treated so that a portion where the liquid is distributed has higher hydrophobicity than the other portion.

Preferably, the liquid distributor includes a guide projection formed between the respective protrusions, the guide projection projecting at a predetermined distance in a thickness direction of the liquid distributor and extending downward along the edge of the protrusion. The projection height of the guide projection gradually decreases along the edge of the protrusion. Further, the top surface of the guide projection forms an acute angle with the surface of the liquid distributor.

Preferably, the liquid distributor includes a distribution protrusion formed in the upper end surface of a portion where the liquid is separated, the distribution protrusion having a peak corner facing upward.

Preferably, the liquid measuring unit includes a plurality of liquid collecting containers for collecting distributed liquid and a plurality of measuring sensors for detecting an amount of liquid collected in the respective liquid collecting containers. The measuring sensors serve to measure the mass of liquid.

Preferably, the liquid distributor has an inclined surface formed between the upper end surface and the front and rear surfaces thereof such that the liquid is induced to flow toward the front and rear surfaces of the liquid distributor.

According to another aspect of the invention, a method of measuring ejection uniformity of a slit nozzle comprises distributing liquid for each predetermined interval with respect to a widthwise direction of the slit nozzle, the liquid being ejected from the slit nozzle; separately collecting the distributed liquid; and measuring an amount of the collected liquid.

Preferably, the collecting of the distributed liquid includes separately dropping the distributed liquid; and collecting the dropped liquid.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a general slit coater;

FIG. 2 is a sectional view showing a state where photoresist is coated on a substrate by the slit coater shown in FIG. 1;

FIG. 3 is a schematic front view of an apparatus for measuring ejection widthwise uniformity of slit nozzle according to the invention;

FIG. 4 is a perspective view illustrating a liquid distributor of the apparatus for measuring ejection uniformity of slit nozzle according to the invention;

FIGS. 5 and 6 are diagrams for explaining a state where liquid is distributed by the liquid distributor shown in FIG. 4;

FIGS. 7 and 8 are perspective views illustrating modifications of the liquid distributor according to the invention; and

FIGS. 9 and 10 are perspective views illustrating other modifications of the liquid distributor according to the invention.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

Hereinafter, an apparatus and method for measuring widthwise ejection uniformity of slit nozzle according to the present invention will be described in detail with reference to the accompanying drawings. The apparatus for measuring ejection uniformity according to the invention serves to measure ejection uniformity of photoresist to be ejected by the slit nozzle of the slit coater described in the related art. The descriptions of the slit coater will be omitted.

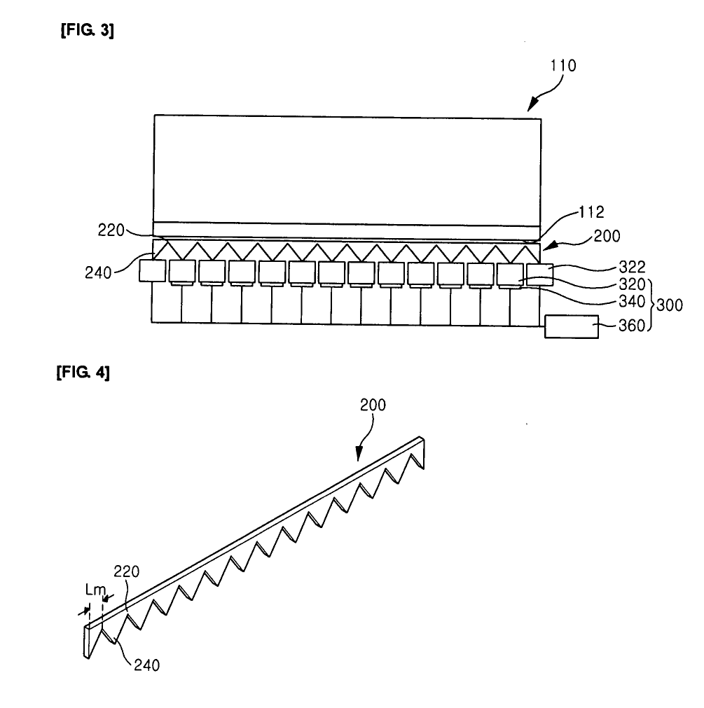

FIG. 3 is a schematic front view of an apparatus for measuring widthwise ejection uniformity of slit nozzle according to the invention. FIG. 4 is a perspective view illustrating a liquid distributor of the apparatus for measuring ejection uniformity of slit nozzle according to the invention.

Referring to FIG. 3, the apparatus for measuring widthwise ejection uniformity of slit nozzle according to the invention includes a liquid distributor 200, which uniformly distributes liquid to be ejected from a slit nozzle 110 by the constant amount, and a liquid measuring unit 300 which measures an ejected amount of liquid Lq distributed by the liquid distributor 200.

As shown in FIG. 4, the liquid distributor 200 with a thickness of less than 1 mm is formed in a strip shape so as to extend in a widthwise direction of the slit nozzle 110, the liquid distributor 200 being formed of stainless steel. The liquid distributor 200 is positioned under the slit nozzle 110 such that the upper end surface of the liquid distributor 200 is spaced at a predetermined distance from an ejection port 112 which is the lower end of the slit nozzle 110. The lower portions of the liquid distributor 200 are formed in a serrated triangle. The upper portion of the liquid distributor 200 with respect to the serrated triangle-shaped lower portion is composed of a liquid separating section 220 having a small height and a liquid collecting section having a large height. That is, the liquid distributor 200 has a plurality of protrusions formed in an inversed triangle and connected in parallel in a widthwise direction of the slit nozzle 110. A portion where the protrusions adjacent to each other are connected serves as the liquid separating section 220, and the other portion of each protrusion serves as the liquid collecting section 240.

FIGS. 3 and 4 show that the side-to-side length of the liquid distributor 200 is the same as the width of the slit nozzle 110. However, a fixing section (not shown) is further formed in either side of the liquid distributor 200 such that the liquid distributor 200 can be fixed to the outside. That is, it can be found that only a portion of the liquid distributor 200 is shown in FIGS. 3 and 4. When the slit nozzle has a width of more than 2000 mm, the liquid distributor 200 has a larger length than the width of the slit nozzle. Further, the liquid distributor 200 is formed of a metallic plate with a thickness of 1 mm. In order that the liquid distributor 200 formed in such a shape is spaced in parallel at a predetermined distance from the ejection port 112 of the slit nozzle 110, the liquid distributor 200 should be firmly fixed, while maintaining a flat shape. For this, it is preferable that the fixing section formed in either side of the liquid distributor 200 is firmly fixed, while receiving a constant tension from an external jig (not shown).

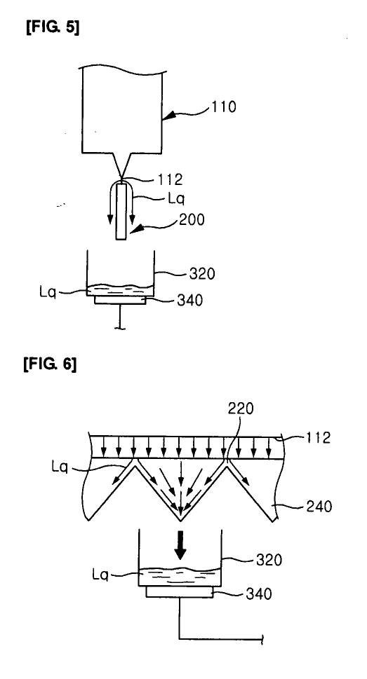

When liquid Lq to be ejected from the slit nozzle 110 reaches the top surface of the liquid distributor 200, the ejected liquid Lq flows downward along the shape of the liquid distributor 200. That is, as shown in FIGS. 5 and 6, the liquid Lq ejected in the vicinity of the liquid separating section 220 at the upper end of the liquid distributor 200 diverges right and left so as to flow toward the liquid collecting section 240. Further, the liquid Lq ejected in the upper region of the liquid collecting section 240 flows downward and meets with the liquid Lq which has been ejected in the vicinity of the liquid separating section 220 so as to flow toward the liquid collecting section 240. Then, the liquid Lq is collected in the lower end of the liquid collecting section 240, which is the apex of a triangle. Accordingly, the liquid distributor 200 distributes the liquid Lq to be ejected from the slit nozzle 110 by the constant amount which is collected by each of the liquid collecting sections 240. Therefore, it is preferable that the liquid collecting sections 240 are arranged at a uniform distance. As the number of liquid collection sections 240 increases, the uniformity can be measured with more precise resolution.

Preferably, the liquid distributor 200 is spaced at less than a predetermined distance from the ejection port 112 which is the lower end of the slit nozzle 110. When the distance is large, the liquid Lq ejected from the ejection port 112 of the slit nozzle 110 is lumped into droplets due to a surface tension. Then, the liquid Lq does not uniformly flow into the liquid distributor 200. As a result, the liquid distributor 200 cannot distribute the liquid uniformly. The distance differs in accordance with a type of liquid. When photoresist PR to be used in the slit coater is used as liquid, the distance is preferably set to less than 300 μm.

Meanwhile, when the liquid Lq to be ejected from the upper end of the liquid distributor 200 is uniformly distributed by the constant amount and then drops into the liquid measuring unit 300 through the liquid collecting section 240, it is preferable that the liquid does not remain on the liquid distributor 200 but all drops into the liquid measuring unit 300. For this, the liquid distributor 200 is preferably surface-treated so that hydrophobicity is provided on the surface of the liquid distributor 200. Then, the liquid Lq is not adhered on the liquid distributor 200. That is, the liquid distributor 200 is not wetted by the liquid Lq. For example, hydrophobic coating can be performed on the surface of the liquid distributor 200, or surface roughness can be reduced.

The liquid measuring unit 300 includes a plurality of liquid collecting containers 320 disposed under the liquid distributor 200, a plurality of measuring sensors 340 which support the respective liquid collecting containers 320 and measure an amount of liquid Lq to be collected by the respective liquid collecting containers 320, and a measuring unit 360 which is connected to each of the measuring sensors 340 and receives a signal therefrom so as to measure an amount of liquid Lq flowing in each of the liquid collecting containers 320 such that the uniformity of the ejected liquid Lq is measured. The measuring sensor 340 may include a mass sensor such as a load cell which detects the mass of the collected liquid Lq.

Each of the liquid collecting containers 320 has an opening formed in the upper portion thereof and is disposed under each of the liquid collecting sections 240. Preferably, the opening of the liquid collecting container 320 is formed to have a large diameter such that liquid Lq to drop from each of the liquid collecting sections 240 flows into the corresponding liquid collecting container 320. In a general case, liquid Lq ejected from the slit nozzle 100 is separated by the liquid separating section 220 and is collected into the liquid collecting section 240. Then, the collected liquid Lq drops into the liquid collecting container 320 from the lower end (peak) of the liquid collecting section 240. However, after liquid Lq is separated by the liquid separating section 220, the liquid Lq may not reach the peak but drop in the middle. Even in this case, the liquid collecting container 320 should collect the liquid Lq. Therefore, the opening of the liquid collecting container 320 is formed to have as a large diameter as possible.

Meanwhile, the liquid separating section 220 positioned to correspond to either end of the slit nozzle 110 needs to be examined. As shown in FIGS. 3 and 4, the liquid collecting section 240 which is inward adjacent to the liquid separating section 220 is positioned so as to correspond to the liquid collecting container 320 having the measuring sensor 340 provided thereon. Further, the liquid collecting section 240 in the outermost side of the liquid distributor 200 is positioned so as to correspond to an election liquid collecting container 322 having no measuring sensor 340. This is because, when the slit nozzle 110 coats photoresist PR onto a substrate, the thickness uniformity of the photoresist PR to be coated from the widthwise edge of the slit nozzle 110 is not considered to be important. Therefore, a distance Lm from the liquid separating section 220, positioned to correspond to either end of the slit nozzle 110, to the leading end surface of the end of the slit nozzle 110 corresponds to the width of a region where the thickness uniformity of coated photoresist PR is not important. In this region, the liquid Lq is simply collected. If necessary, however, even the liquid collecting container 322 may be provided with the measuring sensor 340 such that an amount of distributed liquid can be measured in this region.

The apparatus for measuring ejection uniformity according to the invention serves to measure the ejection uniformity of photoresist PR to be ejected by a slit coater which coats such a material as photoresist PR onto a glass substrate at a constant thickness. For this, the apparatus for measuring ejection uniformity according to the invention is disposed under the slit nozzle 110 which actually ejects photoresist PR. Then, the photoresist PR is ejected from the slit nozzle 110 such that the distribution of the photoresist PR according to the widthwise direction of the slit nozzle 110 is measured.

That is, in order to measure the uniformity of photoresist PR using the apparatus for measuring ejection uniformity, the photoresist PR can be used as liquid Lq. In this case, however, since the photoresist PR to be used in the apparatus for measuring ejection uniformity is expensive and should be discarded, a lot of cost is required. Further, if the ejected photoresist PR which is highly volatile is not evaporated uniformly in a widthwise direction of the slit nozzle 110, the apparatus for measuring ejection uniformity according to the invention cannot measure the uniformity of the photoresist PR with reliability. Therefore, as for liquid to be used in the apparatus for measuring ejection uniformity, it is preferable to use water which is easily obtained and is not volatile.

When an ejected amount of liquid Lq according to the widthwise direction of the slit nozzle 110 is measured for each interval, an absolute value and ejection behavior for each interval are not measured, but the distribution for each interval is relatively measured. Therefore, the photoresist PR or a material having the same physical property as the photoresist PR does not need to be used.

In order to measure the distribution of liquid Lq according to the widthwise direction of the slit nozzle 110 by using the ejection uniformity measuring apparatus constructed in such a manner, the slit nozzle 110 and the ejection uniformity measuring apparatus are fixedly installed so that the liquid distributor 200 is disposed in parallel under the ejection port 112 of the slit nozzle 110 while being spaced at a constant distance from the ejection port 112.

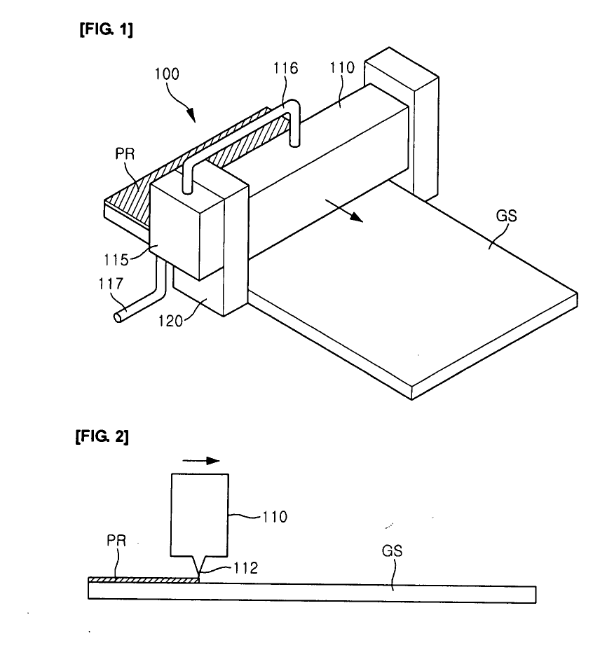

After that, water, not photoresist PR, is supplied to the photoresist supply section 115 through the second photoresist supply line 117 of the slit coater (refer to FIG. 1) described in the related art. Next, the pump of the photoresist supply section 115 is driven so as to supply the water to the slit nozzle 110 through the first photoresist supply line 116. Then, the water is ejected onto the upper portion of the liquid distributor 200 through the ejection port 112 of the slit nozzle 110. Typically, an amount of photoresist PR to be ejected by the slit nozzle 110 is about 0.5 to 15.0 cc/sec in an actual coating process, which is determined by the size of a substrate and the transfer speed of the slit nozzle 110. Therefore, an ejected amount of liquid Lq is set to about 1.0 to 12.0 cc/sec.

As shown in FIGS. 5 and 6, the water to be ejected onto the liquid distributor 200, that is, the liquid Lq is separated for a predetermined interval by reference to the ejection separating section 220 so as to flow toward the lower end of the liquid collecting section 240. The liquid Lq flowing toward the lower end of the liquid collecting section 240 drops from the lower end (peak) of the liquid collecting section 240 so as to be collected in the ejection collecting container 320 disposed under the liquid collecting section 240. That is, the liquid Lq to be ejected onto the liquid distributor 200 is distributed for a predetermined interval by reference to the liquid separating section 220 so as to be collected in each of the liquid collecting containers 320.

The measuring sensors 340 supporting the respective liquid collecting containers 320 detect an amount of liquid Lq collected in the liquid collected containers 320 so as to transmit an amount signal to the measuring unit 360. The measuring unit 360 calculates an amount of liquid Lq collected in each of the liquid collecting containers 320. Then, the measuring unit 360 calculates the distribution of liquid Lq so as to measure the uniformity of ejected liquid Lq according to the widthwise direction of the slit nozzle 110.

Preferably, the measuring of the uniformity of liquid Lq is repeatedly performed about ten times, in order to secure reliability. When the measuring is completed, the space of the ejection port 112 of the slit nozzle 110 is adjusted on the basis of the uniformity. The measuring of the uniformity of liquid and the adjusting of the space of the ejection port 112 are repeatedly performed until desirable uniformity of ejected liquid is obtained.

Meanwhile, when the liquid Lq separated from the liquid separating section 220 of the liquid distributor 200 drops down from the liquid distributor 200 while flowing toward the liquid collecting section 240, it is likely that the corresponding liquid collecting container 320 cannot collect all the liquid Lq. That is, it has been described that the opening of the liquid collecting container 320 is preferably formed to have as a large diameter as possible. However, since the liquid collecting containers 320 are adjacent to each other, there is a limit in enlarging the diameter of the opening. Therefore, under the liquid separating section 220, two of the liquid collecting containers 320 are disposed to be spaced at a predetermined distance from each other. Therefore, when liquid Lq drops from the liquid distributor 200 immediately after being separated by the ejection separating section 220, the liquid Lq is not collected by the liquid collecting container 320.

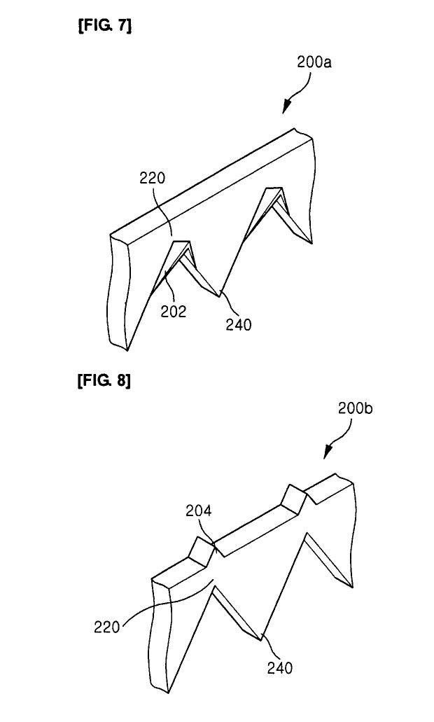

FIG. 7 is a diagram showing a modification of the liquid distributor which is one of the main components of the invention.

The liquid distributor 200a shown in FIG. 7 further includes a guide projection 202 in addition to the same construction as the liquid distributor 200 shown in FIG. 4. In such a structure, after liquid Lq is separated by the election liquid separating section 220, the liquid Lq flows along the guide projection and then drops down.

The guide projection 202 is formed to project at a predetermined distance under the liquid separating section 220 in a thickness direction of the liquid distributor 202a and to extend along the edge of the inverted-triangle protrusion. Preferably, the guide projection 202, of which the projection height is gradually reduced along the edge, is integrally formed in the body of the liquid distributor 202a or is separately formed and then attached to the body of the liquid distributor 202a. When the guide projection 202 is formed so that the projection height thereof is gradually reduced, liquid adhered on the guide projection 202 flows downward along the guide projection 202 into the body of the liquid distributor 202a, without staying on the guide projection 202. In FIG. 7, it is shown that the guide projection 202 is formed up to the middle of the edge of the inverted-triangle protrusion. Without being limited thereto, however, the guide projection 202 may be formed to extend to the lower end (peak) of the liquid collecting section 240. Preferably, the top surface of the guide projection 202 is formed to be inclined toward the liquid separating section 220 and the liquid collecting section 240. That is, it is preferable that the surface of the liquid distributor 202a and the top surface of the guide projection 202 form an acute angle which is smaller than a right angle. In such a structure, liquid Lq is induced to flow toward the liquid separating section 220 and the liquid collecting section 240, without overflowing to the outside of the guide projection 202.

Further, such a guide projection 202 serves to enhance the strength of the liquid distributor 202a. In order that the liquid distributor is spaced in parallel at a predetermined distance from the ejection port 112 of the slit nozzle 110, the liquid distributor should be firmly fixed and maintained in a flat shape in a state where a predetermined tension is applied to both ends thereof. At this time, the liquid separating section 220 with a small height inevitably has a small strength. In order to accurately separate liquid Lq, it is preferable that the liquid separating section 220 is formed to have as a small height as possible. In terms of strength, however, the liquid separating section 220 needs to have a predetermined height. The guide projection 202 can reinforce the strength of the liquid separating section 220. Accordingly, the height of the liquid separating section 220 can be reduced so that liquid Lq can be further accurately separated.

On the other hand, another modification for enhancing the strength of the liquid separating section 220 and further accurately separating election liquid Lq is shown in FIG. 8.

A liquid distributor 200b shown in FIG. 8 further includes a distribution protrusion 204 in addition to the same construction as the liquid distributor 200 shown in FIG. 4. The distribution protrusion 204 serves to help liquid Lq to be further accurately separated by the liquid separating section 220.

As shown in FIG. 8, the distribution protrusion 204 is formed in a triangle-prism shape so as to protrude on the upper surface of the liquid separating section 220. The apex of the triangle prism faces upward. In this case, when the upper corner of the distribution protrusion 204 is disposed so as to come in contact with the ejection port 112 of the slit nozzle 110, liquid Lq is separated at the upper corner of the distribution protrusion 204 at the same time when the liquid Lq is ejected from the ejection port 112. Then, the liquid Lq flows along the inclined surface of the distribution protrusion 204 toward the liquid collecting section 240, without passing through the liquid separating section 220. In this case, the liquid separating section 220 can be formed to have a slightly large height, thereby enhancing the strength of the liquid distributor 202b.

In the above description, the distribution protrusion 204 is formed on the upper end surface of the liquid separating section 220. However, the distribution protrusion 204 may be formed to protrude at a predetermined distance in the thickness direction of the liquid distributor 200b. Further, the distribution protrusion 204 and the guide projection 202 shown in FIG. 7 may be formed together in the liquid distributor 200b.

Meanwhile, in order that liquid Lq is further accurately separated by the liquid separating section 220, another construction can be considered, in addition to the distribution protrusion 204 shown in FIG. 8. For example, when the liquid separating section 220 and the liquid collecting section 240 of the liquid distributor 200 shown in FIG. 4 are surface-treated, hydrophobic coating may be differently performed on the liquid separating section 220 and the liquid collecting section 240 or surface roughness may be differently provided on the liquid separating section 220 and the liquid collecting section 240. That is, the coating may be performed using different methods such that the liquid separating section 220 exhibits more excellent hydrophobicity than the liquid collecting section 240, that is, the liquid separating section 220 has lower wettability than the liquid collecting section 240. Alternately, the surface roughness of the liquid separating section 220 can be reduced than that of the liquid collecting section 240.

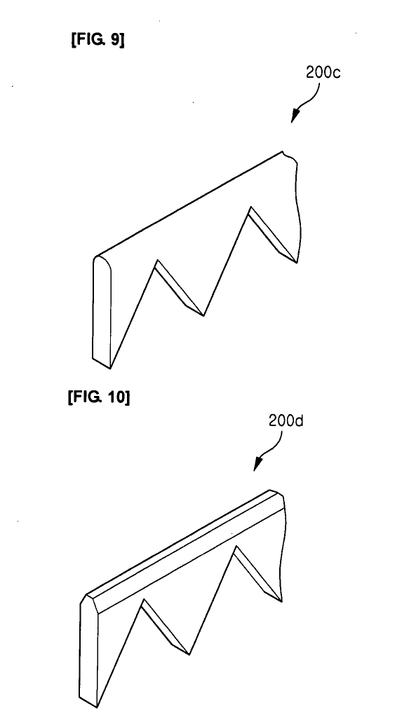

In the above-described embodiment, the upper end surface and the front and rear surfaces of the liquid distributor 200 are formed to meet each other. Therefore, when liquid Lq flows on the front and rear surfaces after being ejected onto the upper end surface of the liquid distributor 200, the liquid Lq may not smoothly flow. In order to solve such a problem, the upper end surface of the liquid distributor can be formed in various shapes. That is, an inclined surface is formed between the upper surface and the front and rear surfaces of the liquid distributor such that liquid Lq ejected on the upper end surface of the liquid distributor can easily flow on the front and rear surfaces. Like a liquid distributor 200c shown in FIG. 9, the upper end surface thereof may be formed to have a semicircular cross-section. Alternately, like a liquid distributor 200d shown in FIG. 10, the upper end surface thereof may be formed to have a trapezoidal cross-section.

In addition to the above-described modifications, the upper end surface of the liquid distributor 200c shown in FIG. 9 may be varied into a slightly flat shape, or the corners of the liquid distributor 200d shown in FIG. 10, where the respective surfaces meet each other, may be formed in a circular shape. That is, the shape of the liquid distributor can be changed in various manners.

According to the invention, the apparatus and method for measuring ejection uniformity of slit nozzle can simply and precisely measure the widthwise ejection uniformity of photoresist to be ejected onto the substrate by the slit nozzle.

Through the measuring of the ejection uniformity, the space of the ejection port of the slit nozzle can be further easily adjusted. Therefore, a preparation time required for coating a substrate by using a slit coater and the resultant overall process time can be reduced.

Further, since photoresist does not need to be used for measuring widthwise ejection uniformity of photoresist, expensive photoresist is not wasted. Accordingly, it is possible to reduce a disposal cost of photoresist to be discarded.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus for measuring ejection uniformity of a slit nozzle, the apparatus comprising:
a liquid distributor that distributes liquid for each predetermined interval with respect to a widthwise direction of the slit nozzle, the liquid being ejected from the slit nozzle; and
a liquid measuring unit that measures an amount of liquid distributed by the liquid distributor.

2. The apparatus according to claim 1,
wherein the liquid distributor with a predetermined thickness is formed in a strip shape so as to extend in a widthwise direction of the slit nozzle, the liquid distributor having a plurality of serrated protrusions formed in the lower portion thereof such that liquid ejected into a connection portion between the protrusions is distributed left and right so as to flow toward the respective protrusions.

3. The apparatus according to claim 2,
wherein the plurality of protrusions are formed in an inverted triangle and are continuously connected in parallel to each other.

4. The apparatus according to claim 1,
wherein the liquid is water.

5. The apparatus according to claim 1,
wherein the liquid distributor is surface-treated so as to have hydrophobicity with respect to the liquid.

6. The apparatus according to claim 5,
wherein the liquid distributor is surface-treated so that a portion where the liquid is distributed has higher hydrophobicity than the other portion.

7. The apparatus according to claim 2,
wherein the liquid distributor includes a guide projection formed between the respective protrusions, the guide projection projecting at a predetermined distance in a thickness direction of the liquid distributor and extending downward along the edge of the protrusion.

8. The apparatus according to claim 7,
wherein the projection height of the guide projection gradually decreases along the edge of the protrusion.

9. The apparatus according to claim 7,
wherein the top surface of the guide projection forms an acute angle with the surface of the liquid distributor.

10. The apparatus according to claim 2,
wherein the liquid distributor includes a distribution protrusion formed on the upper end surface of a portion where the liquid is separated, the distribution protrusion having a peak corner facing upward.

11. The apparatus according to claim 1,
wherein the liquid measuring unit includes a plurality of liquid collecting containers for collecting distributed liquid and a plurality of measuring sensors for detecting an amount of liquid collected in the respective liquid collecting containers.

12. The apparatus according to claim 11,
wherein the measuring sensors serve to measure the mass of liquid.

13. The apparatus according to claim 1,
wherein the liquid distributor has an inclined surface formed between the upper end surface and the front and rear surfaces thereof such that the liquid is induced to flow toward the front and rear surfaces of the liquid distributor.

14. A method of measuring ejection uniformity of a slit nozzle, the method comprising:
distributing liquid for each predetermined interval with respect to a widthwise direction of the slit nozzle, the liquid being ejected from the slit nozzle;
separately collecting the distributed liquid; and
measuring an amount of the collected liquid.

15. The method according to claim 14,
wherein the collecting of the distributed liquid includes:
separately dropping the distributed liquid; and
collecting the dropped liquid.
